(19) United States
(12) Patent Application Publication
(10) Pub. No.: US 2009/0207042 A1
(43) Pub. Date: Aug. 20, 2009

(54) WIRELESS REMOTE METER READING APPARATUS AND DRIVING METHOD THEREOF

(75) Inventors: Keun Hyung PARK, Cheongju-si (KR); Dae Young LEE, Daejeon (KR); Gi Byung KNAG, Daejeon (KR); Bong Yong UH, Cheongju-si (KR)

Correspondence Address: Workman Nydegger;1000 Eagle Gate Tower, 60 East South Temple, Salt Lake City, UT, 84111, US

(73) Assignee: HITEC C&I, Seoul (KR)

(21) Appl. No.: 12/101,016

(22) Filed: Apr. 10, 2008

(30) Foreign Application Priority Data
Feb. 18, 2008 (KR) 10-2008-0014561

(51) Int. Cl. G08C 15/06

(52) U.S. Cl. 340/870.02

(57) ABSTRACT

A wireless remote meter reading apparatus and driving method thereof are used to reduce the cost of detecting the amount of energy consumption and to enhance the detection efficiency, so as to facilitate the detection of the energy consumption amount of tap water, gas, electricity, calorie or the like. Each of a set of short-range wireless networks includes meter reading units. Regenerative repeating units and a data centralizing unit configure a cell unit. A base station controller collects meter-reading data from the short-range wireless networks configured by the cell unit via a base station. A meter reading server supplies a control signal to the meter reading units, the regenerative repeating units and the data centralizing unit using a long-range network, such as GSM, GPRS, CDMA, SMSC via a mobile switch or an internet network. The meter reading server is supplied with the meter reading data via the long-range network.

This application claims the benefit of the Korean Patent Application No. 10-2008-0014561, filed on Feb. 18, 2008, which is hereby incorporated by reference as if fully set forth herein.

### BACKGROUND OF THE INVENTION

1. Field of the Invention

The present invention relates to a wireless remote meter reading system, and more particularly, to a wireless remote meter reading apparatus and driving method thereof. Although the present invention is suitable for a wide scope of applications, it is particularly suitable for reducing a cost for detecting an energy consumption amount and enhancing detection efficiency by facilitating the energy consumption amount of tap water, gas, electricity, calorie or the like to be detected.

2. Discussion of the Related Art

Recently, as the number of consumers is incremented with the industrial development, an energy consumption amount abruptly increases. So, the demand for nationwide efficient energy management and supply measures rises.

Generally, in order to read an energy consumption amount of tap water, gas, electricity, calorie or the like, a meterman visits each consumer, checks a meter, reads a integrated numerical value thereof, and then records the read value one by one. After completion of the meter reading in this manner, the meterman calculates a bill amount by inputting the recorded integrated numerical value to a computer and then bills the corresponding consumer for it.

Yet, if the above-mentioned meter reading methods are executed, errors are frequently generated in the courses of reading an integrated numerical value on a meter, recording the integrated numerical value, inputting the recorded integrated numerical value and the like.

To improve the above method of personal meter reading of the meterman, various methods have been proposed. One of the various methods is a wireless meter reading method using an RF module. In the wireless meter reading method using the RF module, an RF module is attached to a meter of each consumer and a meterman personally visits a meter reading area by carrying a mobile terminal provided with an RF module. Hence, it is able to collect meter reading data from the corresponding meter by wireless.

The wireless meter reading method using the RF module compensates for problems of the personal meter reading in part and is advantageous in that meter reading is possible without entering each consumer house. And, it is also advantageous in that it is unnecessary to input meter reading data to a computer one by one.

However, the meter reading processes should be personally conducted by the meterman, whereby a mete reading cost is not reduced.

### SUMMARY OF THE INVENTION

Accordingly, the present invention is directed to a wireless remote meter reading apparatus and driving method thereof that substantially obviate one or more problems due to limitations and disadvantages of the related art.

An object of the present invention is to provide a wireless remote meter reading apparatus and driving method thereof, by which a cost for detecting an energy consumption amount is reduced and by which detection efficiency is enhanced, in a manner of facilitating the energy consumption amount of tap water, gas, electricity, calorie or the like to be detected.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a wireless remote meter reading apparatus according to the present invention includes a plurality of short-range wireless networks, each comprising a plurality of meter reading units respectively having ZigBee communication modules, a plurality of regenerative repeating units and a data centralizing unit, to configure a cell unit, a base station controller collecting a plurality of meter-reading data from a plurality of the short-range wireless networks configured by the cell unit via at least one base station, and a meter reading server supplying a control signal to a plurality of the meter reading units, a plurality of the regenerative repeating units and the data centralizing unit using at least one long-range network selected from the group consisting of GSM, GPRS, CDMA, SMSC via a mobile switch and an internet network, the meter reading server supplied with a plurality of the meter reading data via the long-range network.

In another aspect of the present invention, a method of driving a wireless remote meter reading apparatus, in which the wireless remote meter reading apparatus includes a plurality of short-range wireless networks, each comprising a plurality of meter reading units respectively having ZigBee communication modules, a plurality of regenerative repeating units and a data centralizing unit, to configure a cell unit and a meter reading server supplied with a plurality of the meter reading data using at least one long-range network selected from the group consisting of GSM, GPRS, CDMA, SMSC via a mobile switch and an internet network, includes the steps of: initializing the wireless remote meter reading apparatus, generating and supplying a control signal to the data centralizing unit via the long-range network, selecting a meter reading scheme by analyzing the control signal through the data centralizing unit, and collecting the meter reading data according to the selected meter reading scheme by configuring a short-range network.

Accordingly, the present invention provides the following effects or advantages.

First of all, the present invention facilitates an energy consumption amount of tap water, gas, electricity, calorie or the like to be detected, thereby reducing a meter reading cost for detecting the energy consumption amount.

Secondly, the present invention raises detection efficiency of an energy consumption amount and enables data collection for energy management and supply planning and accurate pattern analysis.

Thirdly, the present invention establishes a short-range wireless communication network and a long-range backbone network to transmit meter reading data, thereby enabling an inexpensive cost for establishing a wireless remote meter reading apparatus.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic block diagram of a wireless remote meter reading apparatus according to an embodiment of the present invention;

FIG. 2 is a schematic block diagram of a data centralizing unit shown in FIG. 1;

FIG. 3 is a schematic block diagram of a regenerative repeating unit shown in FIG. 1;

FIG. 4 is a schematic block diagram of a meter reading unit shown in FIG. 1;

FIG. 5 is a schematic block diagram of a mobile communication GW shown in FIG. 1;

FIG. 6 is a schematic block diagram of a wireless remote meter reading apparatus using a long-range network by CDMA; and

FIG. 7 is a flowchart for a method of driving a wireless remote meter reading apparatus according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Wireless remote meter reading apparatus and driving method thereof according to the present invention are explained in detail as follows.

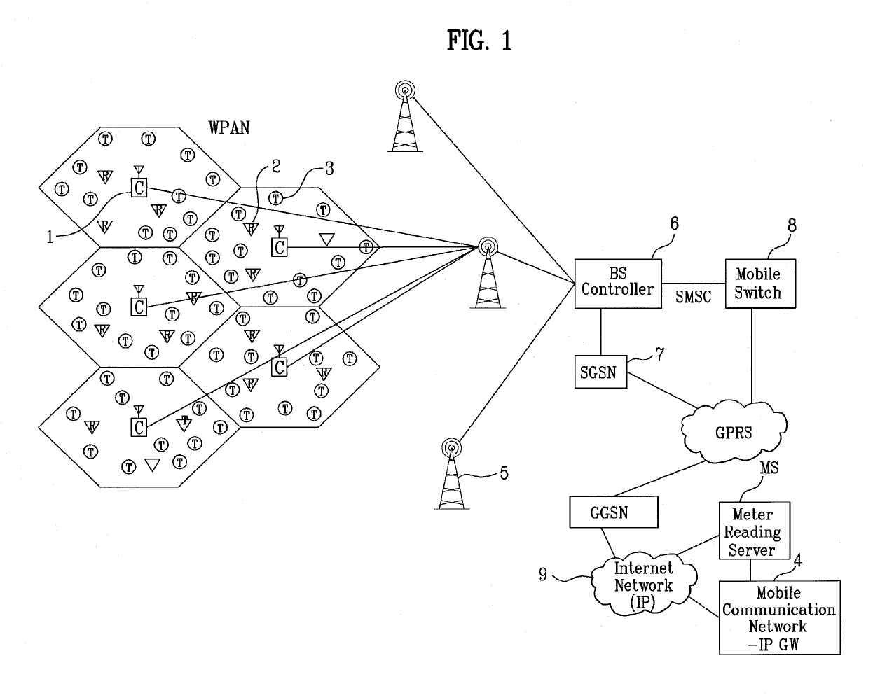

FIG. 1 is a schematic block diagram of a wireless remote meter reading apparatus according to an embodiment of the present invention.

Referring to FIG. 1, a wireless remote meter reading apparatus according to an embodiment of the present invention includes a plurality of short-range wireless networks (wireless personal area networks: WPANs), each of which includes a plurality of meter reading units 3 respectively having ZigBee communication modules, a plurality of regenerative repeating units 2 and a data centralizing unit 1, to configure a cell unit, a base station controller 6 collecting meter-reading data from a plurality of the short-range wireless networks (WPAN) configured by the cell unit via at least one base station 5, and a meter reading server (MS) supplying a control signal to a plurality of the meter reading units 3, a plurality of the regenerative repeating units 2 and the data centralizing unit 1 using at least one long-range network selected from the group consisting of GSM, GPRS, CDMA, SMSC (short message service center) via a mobile switch 8 and Internet network 9, the meter reading server (MS) supplied with the meter reading data via the long-range network.

The wireless remote meter reading apparatus according to the present invention further includes a mobile communication GW 4 controlling each of the meter reading units 3, each of the regenerative repeating units 2 and the data centralizing unit 1 via the meter reading server (MS) by playing a role as a gateway between the meter reading server (MS) and the long-range network.

In order to read a meter for an energy consumption amount consumed by each consumer, the short-range wireless network (WPAN) is cellularized into a plurality of areas from an area for meter reading to be configured by a cell unit. In the short-range wireless network (WPAN), meter reading data is collected from a tap-water, calorie or gas meter provided to each meter reading area of the cell unit and is then transmitted to the base station 5.

The short-range wireless network (WPAN) is configured in a manner of being cellularized within a radius of about 1 km trough topographical survey and radio wave environment analysis of a meter reading area, establishing the data centralizing unit 1 at a central part of the cellularized meter reading area and installing the meter reading unit 3 at each consumer. Meter reading data collection of the above-configured short-range wireless network (WPAN) is carried out in accordance with a meter reading request command or meter reading time information contained in the control signal from the meter reading server (MS). In particular, the meter reading server (MS) generates the control signal containing a meter reading command and then makes a request for a meter reading to the data centralizing unit 1. Alternatively, the meter reading server (MS) generates the control signal containing meter reading time information therein and then makes a request for a meter reading.

A plurality of the short-range wireless networks (WPANs) can include ZigBee (IEEE 802.15.4) wireless network capable of mutual bidirectional communication of devices accommodated within a single band on the same level by enabling point-to-point networking.

The short-range wireless network (WPAN) of the present invention includes a plurality of meter reading units 3, a plurality of regenerative repeating units 2 and a data centralizing unit 1 to read meter reading data of each meter in each meter reading area of a cell unit using ZigBee wireless communication and to transmit the read-in meter reading data to a corresponding base station 5. In the short-range wireless network (WPAN) using the ZigBee wireless communication according to the present invention, an arriving distance of transmission signal (i.e., meter reading data and control signal) is short, data size is small and low-power driving is possible. Moreover, in the short-range wireless network (WPAN) using the ZigBee wireless communication according to the present invention, communication interference is small and automatic synchronization is enabled in an area for the short-range wireless network (WPAN) to provide convenience. This short-range wireless network (WPAN) will be explained in detail with reference to the accompanying drawings later.

In order to be supplied with meter reading data from the base station 5 or the base station controller 6 or to transmit control signals, the meter reading server (MS) of the present invention uses at least one long-range network selected from the group consisting of GSM, GPRS, CDMA, SMSC (short message service center) via the mobile switch 8 and the Internet network 9. In this case, the long-range network can include a wide area mobile communication network.

The long-range network of the present invention interoperates with a wireless communication network, as shown in FIG. 1, such as GSM (global system for mobile communication) and GPRS (general packet radio service) and is then able to supply data collected from the base station 5 or the base station controller 6 to the meter reading server (MS) via the internet network 9. In this case, the base station 5 or the base station controller 6 and the GPRS can interoperate with each other via SGSN (serving GPRS supporting node). The interoperation between the GPRS and the internet network 9 is supported via GGSN (gateway GPRS supporting node). The meter reading server (MS) is supplied with the meter reading data via the internet network 9 or the mobile communication GW 4 in the above-explained manner and is also able to control a plurality of the meter reading units 3, a plurality of the regenerative repeating units 2 and the data centralizing unit 1 by supplying control signals to a plurality of the meter reading units 3, a plurality of the regenerative repeating units 2 and the data centralizing unit 1 in a manner reverse to the former manner.

Alternatively, it is able to supply the meter reading data collected by the SMSC (short message service center) to the meter reading server (MS) using the mobile switch 8 connected to the base station controller 6. In this case, the mobile switch 8 is able to supply the collected meter reading data to the meter reading server (MS) using the GPRS and the internet network 9 or can directly supply the collected meter reading data to the meter reading server (MS) in a manner of sending a text message.

As mentioned in the foregoing description, the wireless remote meter reading apparatus according to the present invention configures the long-range network to supply the meter reading data collected from the base station 5 or the base station controller 6 to the meter reading server (MS). In this case, the long-range network can be defined as a backbone network. The long-range network may means a communication line facility for connecting low-speed branch LAN networks to each other or unifying distributed communication devices together. And, the long-range network means a large-scale transport circuit for collecting data from small circuits connected to each other and then transporting the collected data fast. In other words, the long-range network includes a single circuit or a set of several circuits for connection to a wide area communication network from a short-range communication network or may mean a circuit for efficiently extending a distance within a short-range communication network.

GSM is a mobile communication system correspondent to CDMA and corresponds to a sort of mobile communication system based on time division multiple access (TDMA) for dividing each frequency channel by time and asynchronous transport network technology. GPRS is the 2.5 generation mobile phone system enabling high-speed Internet and video communication. SGSN 7, i.e., packet exchange support node is a node responsible for data packet delivery to a mobile subscriber station within a service area. GGSN, i.e., packet gateway support node is a node responsible for an access function between GPRS backbone network and external packet data network and has a function of converting GPRS packet from the SGSN to suitable packet data protocol (PDP) format (e.g., IP, X.25) and then transporting the converted packet and a function of converting a PDP address of incoming packet data to a global mobile communication system (GSM) address of a recipient.

Meanwhile, it is able to configure a long-range network using CDMA (code division multiple access) communication system (not shown in FIG. 1). In this case, CDMA is the digital mobile communication system adopting spread spectrum technology developed by Qualcom, U.S. and is called code division multiple access.

In the following description, explained in detail are a plurality of the meter reading units, a plurality of the regenerative repeating units 2 and the data centralizing unit 1 for reading meter reading data of each meter in each meter reading area of a cell unit using the short-range wireless network (WPAN), and more particularly, ZigBee wireless communication and then transmitting the read-in meter reading data to the corresponding base station 5.

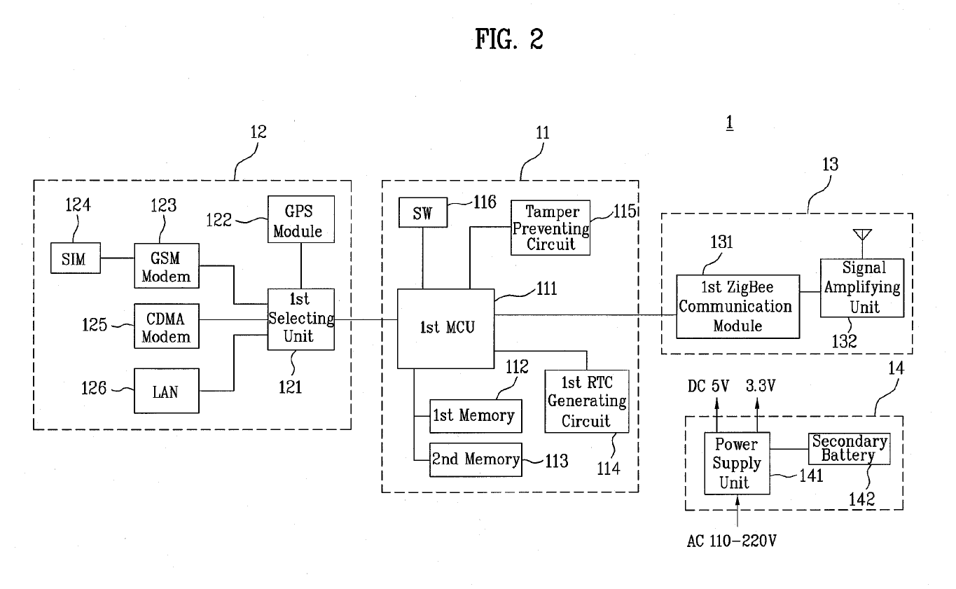

FIG. 2 is a schematic block diagram of a data centralizing unit shown in FIG. 1.

Referring to FIG. 2, the data centralizing unit 1 includes a first data communication unit 12 receiving GPS time and location information and transmitting/receiving control signals from the meter reading server (MS) and the meter reading data by communication via the base station 5, a first ZigBee communication unit 13 receiving the meter reading data from each of the meter reading units 3 and the regenerative repeating units 2 and transmitting the control signals to each of the meter reading units 3 and the regenerative repeating units 2, respectively, a centralized control unit 11 controlling the first ZigBee communication unit 13 and the first data communication unit 12 according to the GPS time and location information and the control signals from the first data communication unit 12, and a first power unit 14 supplying power to the first ZigBee communication unit 13, the first data communication unit 12 and the centralized control unit 11.

The first data communication unit 12 includes a GSM modem 123 having an SIM card 124 and performing GSM communication, a CDMA modem 125 performing CDMA (code division multiple access) communication, a first LAN interface unit 126 performing network communication in local area, a first GPS module 122 receiving GPS time information and location information, and a first selecting unit 121 performing communication by selecting one of the first GPS module 122, the GSM modem 123, the CDMA modem 125 and the first LAN interface unit 126 according to a selection signal from the centralized control unit 11.

The GSM modem 123 is provided to perform GSM type data communication with the base station 5 and may include a GSM specified terminal. Yet, in case that the GSM modem 123 is selected according to the selection signal, the GSM modem 123 transmits the GPS time and location information and the meter reading data, which are supplied from the centralized control unit 11 via the first selecting unit 121, via the base station 5 or supplies controls signals, which are received from the meter reading server (MS) via the base station 5, to the first selecting unit 121.

The CDMA modem 125 is provided to perform CDMA type data communication with the base station 5 and may include a CDMA specified terminal. In case of being selected according to the selection signal, the CDMA modem 125 transmits GPS time and location information supplied from the centralized control unit 11 via the first selecting unit 121 to the base station 5 or supplies control signals inputted from the meter reading server (MS) via the base station 5 to the centralized control unit 11 via the first selecting unit 121.

The first LAN interface unit 126 can include a LAN card or the like to perform network communication in local area such as communication using Ethernet. In this case, the first LAN interface unit 126 supports 10/100Base-T Ethernet, performs a function of ZigBee-IP network gateway, and may support TCP/IP protocol. In case of being selected according to the selection signal, the first LAN interface unit 126 transmits GPS time and location information and the meter reading data, which are supplied from the centralized control unit 11 via the first selection unit 121, via the base station 5 and IP network or supplies control signals received from the meter reading server (MS) via the base station 5 and the IP network to the centralized control unit 11 via the first selecting unit 121.

The first GPS module 122 receives navigation information from a positioning satellite 1 using GPS as one of position based services and then generates its location signal and GPS time information using the received navigation information and algorithm loaded therein. In particular, the first GPS module 122 performs time synchronization of the data centralized unit 1, a plurality of the regenerative repeating units 2 and a plurality of the meter reading units 3 within the short-range wireless network and provides location information for operation maintenance and management. GPS antenna (not shown in the drawing) connected to the first GPS module 122 traces a satellite signal transmitted from the positioning satellite and then obtains a location of the satellite, its location, relative locations of other satellites, GPS time information and the like according to the transmitted satellite signal. Thus, the first GPS module 122 generates its location information and GPS time information and then supplies the generated informations to the centralized control unit 11 via the first selecting unit 121.

The first selecting unit 121 selects one of the GPS module 122, the GSM modem 123, the CDMA modem 125 and the first LAN interface unit 126 according to a selection signal from the centralized control unit 11, receives the control signal, and then transmits the received signal to the centralized control unit 11. In this case, the selection signal can be preset by a user. The selection signal may include a request signal for GPS time information and location information and is a signal set to perform either CDMA communication or network communication in local area. In this case, the selected one of the GSM modem 123, the CDMA modem 125 and the first LAN interface unit 126 according to the selected communication system is enabled and the rest of the two systems are disabled.

The first data communication unit 12 transmits the GPS time information, the location information, the state information and the collected meter reading data to the meter reading server (MS) via the base station 5 under control of the centralized control unit 11 or receives a control signal from the meter reading server (MS) via the base station 5.

The first ZigBee communication unit 13 includes a first ZigBee communication module 131 transmitting a plurality of meter reading data from a plurality of the meter reading units 3 and a plurality of the regenerative repeating units 2 to the centralized control unit 11 and transmitting control signal and GPS time information from the centralized control unit 11 to each of a plurality of the meter reading units 3 and each of a plurality of the regenerative repeating units 2 and a first signal amplifying unit 132 amplifying transmission and reception signals between the first ZigBee communication module 131 and each of a plurality of the meter reading units 3 or each of a plurality of the regenerative repeating units 2.

The first ZigBee communication module 131 can include FFD (full function device) ZigBee module. In particular, the FFD ZigBee module is provided with PAN network establishing, managing and routing functions as well as a basic function for ZigBee communication. The FFD ZigBee module includes a transceiving circuit unit supplying a plurality of meter reading data from a plurality of the meter reading units 3 and a plurality of the regenerative repeating units 2 to the centralized control unit 11 and transmitting control signal and GPS time information from the centralized control unit 11 to each of a plurality of the meter reading units 3 and each of a plurality of the regenerative repeating units 2.

In order to increase a transmission distance of transmitted and received signals, the first signal amplifying unit 132 is able to extend a transmission distance to 1.2 km at LOS from 160 m by amplifying power to maximum power 12 dBm outputtable at 2.4 GHz. In this case, ZigBee antenna is usable as a necessary antenna and uses ½ wave gain 4 to 6 dbi.

The centralized control unit 11 controls the elements of the data centralizing unit 1 including the first data communication unit 12 and the first ZigBee communication unit 12 according to a control signal inputted via the first data communication unit 12 from the meter reading server (MS).

The centralized control unit 11 includes a tamper preventing circuit 115 generating a tamper signal by detecting switching and breakage of the data centralizing unit 1, a first RTC generating unit 114 supplied with GPS time information, maintaining and correcting current time information according to the supplied GPS time information, setting a meter reading time according to the maintained time information and the control signal and generating a meter reading signal every the set meter reading time, a first microcontroller circuit unit (MCU) 111 controlling operation of the data centralizing unit 1 including the first data communication unit 12 and the first ZigBee communication unit 12 according to a control signal, receiving meter reading data via the first ZigBee communication unit 13 according to the control signal and the meter reading signal and supplying the received meter reading data to the first data communication unit 12, a first memory 112 storing basic operation program information on the first MCU 111, a second memory 113 storing state information inputted from the first MCU 111 and informations inputted from a user and storing configuration information on a short-range wireless network (WPAN), and a first switching unit 116 turning on/off a power of the first data centralizing unit 1 and supplying information inputted from the user to the first MCU 111.

The first tamper preventing circuit 115 is able to include at least one vibration sensor. If the switching or breakage of the data centralizing unit 1 takes place, the first tamper preventing circuit 115 detects the switching or breakage of the data centralizing unit 1, generates a tamper signal and then supplies the tamper signal to the first MCU 111. Once the tamper signal is supplied to the first MCU 111, the state information due to tamper is supplied to the meter reading server (MS) via the first data communication unit 12 and is stored in the second memory 113, simultaneously.

The first RTC generating circuit 114 is periodically supplied with GPS time information via the first MCU 111 and then stores the supplied GPS time information. The first RTC generating circuit 114 maintains and corrects current time information according to the supplied GPS time information and then sets a meter reading time according to the maintained time information and an inputted control signal. If it is the set meter reading time, the first RTC generating circuit 114 generates a meter reading signal and then supplies the generated meter reading signal to the first MCU 111. Hence, the first MCU 111 is enabled to collect meter reading data from each of the meter reading units 3 and each of the regenerative repeating units 2.

In this case, since low power time maintenance is very important, the first RTC generating circuit 114 is set to a saving mode to maintain a time with a minimum power. In other words, other elements except the first RTC generating circuit 114 are maintained in standby or disable mode for a time except the set meter reading time or a time for collecting meter reading data according to the control signal from the meter reading server (MS). Hence, the first RTC generating circuit 114 maintains the time information in a low-power mode, stores setting informations and stays in a standby mode. If it is the set meter reading time or if the control signal is received from the meter reading server (MS) the first RTC generating circuit 114 supplies a meter reading signal, e.g., an RTC (real time clock) to the first MCU 111 to enable. If so, the first MCU 111 enables the first data communication unit 12 and the first ZigBee communication unit 13 and may supply enable signals to a plurality of the meter reading units 3 and a plurality of the regenerative repeating units 2.

If supplied with the control signal via the first data communication unit 12, the first MCU 111 generates state information according to the control signal and then supplies the generated state information to the second memory 113 and the first RTC generating circuit 114. The first MCU 111 controls each of a plurality of the meter reading units 3 and each of a plurality of the regenerative repeating units 2 by supplying the control signal thereto via the first ZigBee communication unit 13. In particular, the first MCU 111 supplies the control signal to each of a plurality of the meter reading units 3 and each of a plurality of the regenerative repeating units 2 to enable each of the meter reading units 3 to read meter reading data from a corresponding meter and transmit the read-in meter reading data to the MCU 111. Thus, the first MCU 111 supplies the collected meter reading data to the first data communication unit 12 so that the supplied data can be transmitted to the meter reading server (MS) via a long-range network. For this, the first MCU 111 generates a selection signal according to input information from a user or a control signal and then selects one of the GSM modem 123, the CDMA modem 125 and the first LAN interface 126 using the selection signal. Hence, the selected one is enabled but the rest are disabled. Meanwhile, if a tamper signal is inputted from the first tamper preventing circuit 115, the first MCU 111 directly supplies the state informations to the second memory 113 and the first RTC generating unit 114. By supplying the state information according to the tamper signal to the first data communication unit 12, the first MCU 111 enables the state information to be supplied to the meter reading server (MS).

As mentioned in the foregoing description, the first MCU 111 is able to collect meter reading data by controlling each of the meter reading units 3 according to the control signal inputted from the meter reading server (MS) via the long-range network, the base station 5, the data communication unit 12 or the like.

Meanwhile, the first MCU 111 uses the inputted control signal as state information or converts the control signal to state information, stores the state information in the first RTC generating circuit 114 and the second memory 113, and then enters a power saving mode. If so, the first RTC generating circuit 114 stores a meter reading request time according to the GPS time information and the control signal. If it is the meter reading time, the RTC generating circuit 114 generates an RTC and then supplies the RTC to the first MCU 111. If the meter reading signal is supplied, the first MCU 111 collects meter reading data by controlling each of the meter reading units 3 and then supplies the collected meter reading data to the meter reading server (MS).

The first memory 112 stores basic operation program information of the first MCU 111. In this case, external SRAM is usable as the first memory 112.

The second memory 113 stores state information inputted from the first MCU 111 and informations inputted from a user and also stores configuration information of a short-range network, i.e., configuration information of network and the like. In this case, NAND flash memory is usable as the second memory 113.

The first switching unit 116 includes at least one DIP switch and the like to turn on/off the power of the data centralizing unit 1. The first switching unit 116 received communication type selection information, mobile communication information of peripheral environment, network information and the like and then supplies the received informations to the first MCU 111.

The first power unit 14 includes a power supplying unit 141 converting a level of an externally inputted commercial power to drive voltage levels of the centralized control unit 11, the first data communication unit 12 and the first ZigBee communication unit 13 and supplying them to the centralized control unit 11, the first data communication unit 12 and the first ZigBee communication unit 13, respectively and a secondary battery 142 storing an emergency power. In particular, the first power supplying unit 141 basically receives AC 110˜200 V, converts it to DC of 3.3V and 5V necessary for the data centralizing unit 1, and then supplies the voltages to the respective elements of the data centralizing unit 1. And, the secondary battery 142 stores the emergency power in preparation for an emergency such as blackout and the like. In this case, the power unit 14 may further include a charging circuit, a protection circuit and the like to stably assist the secondary battery 142.

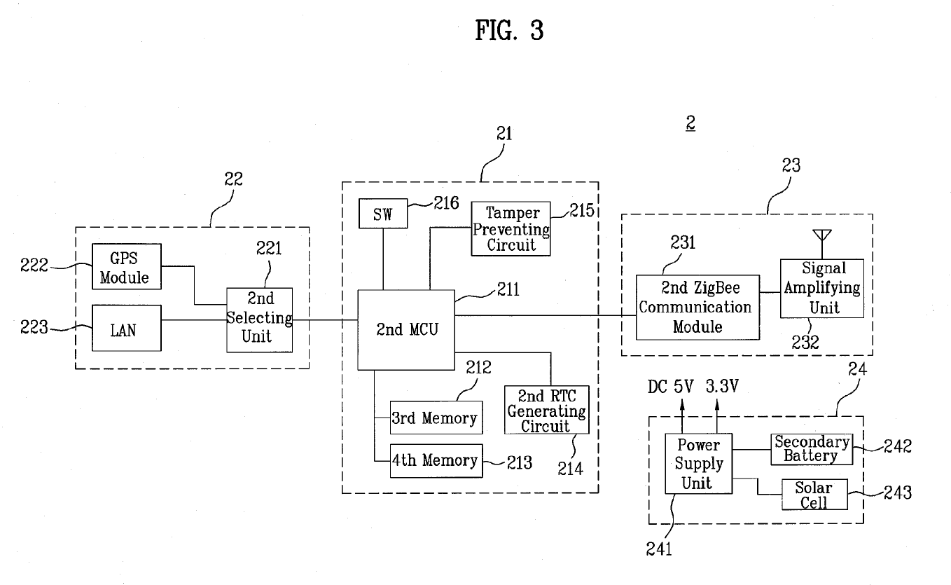

FIG. 3 is a schematic block diagram of a regenerative repeating unit shown in FIG. 1.

Referring to FIG. 3, the regenerative repeating unit 2 shown in FIG. 2 includes a second data communication unit 22 generating GPS time information and performing communication with the base station 5 or the data centralizing unit 1 according to an inputted selection signal, a second ZigBee communication unit 23 receiving meter reading data from a corresponding meter reading unit 3 set correspondent to the second ZigBee communication unit 23, supplying the received meter reading data to the data centralizing unit 1 and transmitting a control signal from the data centralizing unit 1 to the corresponding meter reading unit 3, a repeat control unit 21 controlling the second ZigBee communication unit 23 and the second data communication unit 22 according to the GPS time information and the control signal, and a second power unit 24 supplying power to the second ZigBee communication unit 23, the second data communication unit 22 and the repeat control unit 21.

The above-configured regenerative repeating unit 2 is provided between at least one corresponding meter reading unit 3 and the data centralizing unit 1, and more particularly, to a location enabling a regenerative repetition between the corresponding meter reading unit 3 and the data centralizing unit 1 in case that the corresponding meter reading unit 3 located in a radio wave shadow area is incapable of direct communication with the data centralizing unit 1. Namely, if a communication environment of the meter reading unit 3 is poor or a communication distance is short of if a communication path needs to be altered due to obstacles, the regenerative repeating unit 2 is provided to the location enabling the regenerative repetition between the corresponding meter reading unit 3 and the data centralizing unit 1.

The second data communication unit 22 includes a second LAN interface unit 223 performing network communication in a local area, a second GPS module 222 generating GPS time information and location information, and a second selecting unit 221 transmitting the GPS time information and the location information to the repeat control unit 21 and performing communication with the base station 5 via the second LAN interface unit 223 according to the selection signal.

The second LAN interface unit 223 has the same configuration of the first LAN interface unit 126. The second LAN interface unit 223 performs communication with the base station 5 according to a control signal from the data centralizing unit 1 or supplies control signals inputted from the meter reading server (MS) to the second selecting unit 221. In this case, the second LAN interface unit 223 is disabled while not used by the selection signal.

The second GPS module 222 has the same configuration of the first GPS module 122 and performs the same operation thereof. So, details of the second GPS module 222 are quoted from those of the first GPS module 122.

The second selecting unit 221 receives GPS time information and location information from the second GPS module 222 according to a selection signal from the repeat control unit 21 and then supplies the received informations to the centralized control unit 11. The second selecting unit 221 receives a control signal from the meter reading server (MS) via the second LAN interface unit 223 according to a selection signal and may transmit the received control signal to the repeat control unit 21. In this case, the selection signal includes a request signal from the GPS time information and location information or may be a signal set to receive the control signal from the meter reading server (MS) via the second LAN interface unit 223.

The second ZigBee communication unit 23 receives meter reading data from the meter reading unit 3 provided within a cellularized meter reading area, and more particularly, the meter reading unit 3 in a radio wave shadow area and then supplies the received meter reading data to the repeat control unit 21. The second ZigBee communication unit 23 may transmit control signal and GPS time information inputted from the repeat control unit 21 to the meter reading unit 3.

The second ZigBee communication unit 23 includes a second ZigBee communication module 231 supplying the meter reading data from the meter reading unit 3 to the repeat control unit 21 and transmitting the control signal and the GPS time information from the repeat control unit 21 to the meter reading unit 3 and a second signal amplifying unit 232 amplifying transmission and reception signals between the corresponding meter reading unit 3 and the second ZigBee communication module 231.

The second ZigBee communication module 231 can include an FFD ZigBee module like the first ZigBee communication module 131. Likewise, the second ZigBee communication module 231 includes a transceiving circuit unit supplying the meter reading data from the corresponding meter reading unit 3 to the repeat control unit 21 and transmitting the control signal and the GPS time information from the repeat control unit 21 to the corresponding meter reading unit 3.

The second signal amplifying unit 232 has the same configuration of the first signal amplifying unit 132 and performs the same operation thereof.

The repeat control unit 21 controls elements of the regenerative repeating unit 2 including the second data communication unit 22 and the second ZigBee communication unit 23 according to the control signal supplied from the data centralizing unit 1 via the second data communication unit 22.

The repeat control unit 21 includes a second tamper preventing circuit 215 generating a tamper signal by detecting switching and breakage of the repeat control unit 21, a second RTC generating circuit 214 periodically supplied with GPS time information, maintaining and correcting current time information according to the supplied GPS time information and outputting the maintained time information if the control signal is inputted, a second MCU 211 controlling operations of the elements of the repeat control unit 21 including the second data communication unit 22 and the second ZigBee communication unit 23 according to the control signal, receiving meter reading data via the second ZigBee communication unit 23 according to the control signal and supplying the received meter reading data to the first ZigBee communication unit 13 via the second ZigBee communication unit 23, a third memory 212 storing basic operation program information of the second MCU 211, a fourth memory 213 storing state information inputted from the second MCU 211 and informations inputted from a user and storing configuration information of a short-range wireless network, and a second switching unit 216 forcibly turning on/off the power of the regenerative repeating unit 2 and supplying information inputted from the user to the second MCU 211.

In this case, configurations and operations of the second tamper preventing circuit 215, the second RTC generating circuit 214 and the second switching unit 216 are identical to those of the first tamper preventing circuit 115, the first RTC generating circuit 114 and the first switching unit 116. So, details of the second tamper preventing circuit 215, the second RTC generating circuit 214 and the second switching unit 216 are quoted from those of the first tamper preventing circuit 115, the first RTC generating circuit 114 and the first switching unit 116.

The second MCU 211 controls an operation of each of the elements of the regenerative repeating unit 2 according to the control signal supplied from the meter reading server (MS) via the second data communication unit 22 or the second ZigBee communication unit 23.

If supplied with the control signal, the second MCU 211 generates state information according to the control signal and then supplies the generated state information to the third memory 313 and the second RTC generating circuit 214. And, the second MCU 211 controls the corresponding meter reading unit 3 by supplying the control signal to the corresponding meter reading unit 3 via the second ZigBee communication unit 23. In particular, the second MCU 211 enables the corresponding meter reading unit 3 to read meter reading data from a meter by supplying the control signal to the corresponding meter reading unit 3 and enables the corresponding meter reading unit 3 to transmit the read meter reading data to the second MCU 211. The second MCU 211 supplies the received meter reading data to the second ZigBee communication unit 23 so that the received meter reading data can be supplied to the first ZigBee communication unit 13. Meanwhile, if a tamper signal is inputted from the second tamper preventing circuit 215, the second MCU 211 directly supplies state informations to the fourth memory 213 and the second RTC generating circuit 214. The second MCU 211 supplies the state information according to the tamper signal to the second ZigBee communication unit 23 so that the state information can be supplied to the meter reading server (MS) via the data centralizing unit 1 provided with the first ZigBee communication unit 13.

As mentioned in the foregoing description, the second MCU 211 can be supplied with the meter reading data by controlling the corresponding meter reading unit 3 according to the control signal inputted from the first ZigBee communication unit 13 of the data centralizing unit 1 via the second ZigBee communication unit 232. Meanwhile, the second MCU 211 uses the inputted control signal as the state information or converts the control signal to the state information, stores the state information in the second RTC generating circuit 214 and the fourth memory 214, and then enters a standby mode, i.e., a power saving mode. If it is a meter reading time according to the GPS time information and the state information, the second RTC generating circuit 214 generates a meter reading signal and then supplies the generated meter reading signal to the second MCU 211. So, if the meter reading signal is supplied or if the control signal is inputted from the data centralizing unit 1, the second MCU 211 collects meter reading data by controlling the corresponding meter reading unit 3 and then supplies the collected meter reading data to the data centralizing unit 1 provided with the first ZigBee communication unit 13.

The third memory 212 has the same configuration of the first memory 112 and performs the same operation thereof. The fourth memory 213 has the same configuration of the second memory 113 and performs the same operation thereof. Hence, details of the third and fourth memories 212 and 213 are quoted from those of the first and second memories 112 and 113.

In general, commercial power is not externally inputted to the second power unit 24. So, the second power unit 24 includes a high-efficiency solar cell 243 and a rechargeable battery. In particular, the second power unit 24 includes a second power supply unit 241 converting a level of power inputted from the solar cell 243 to drive voltage levels of the repeat control unit 21, the second data communication unit 22 and the second ZigBee communication unit 23 and supplying the drive voltage levels to the repeat control unit 21, the second data communication unit 22 and the second ZigBee communication unit 23, respectively and a secondary battery 242 storing an emergency power.

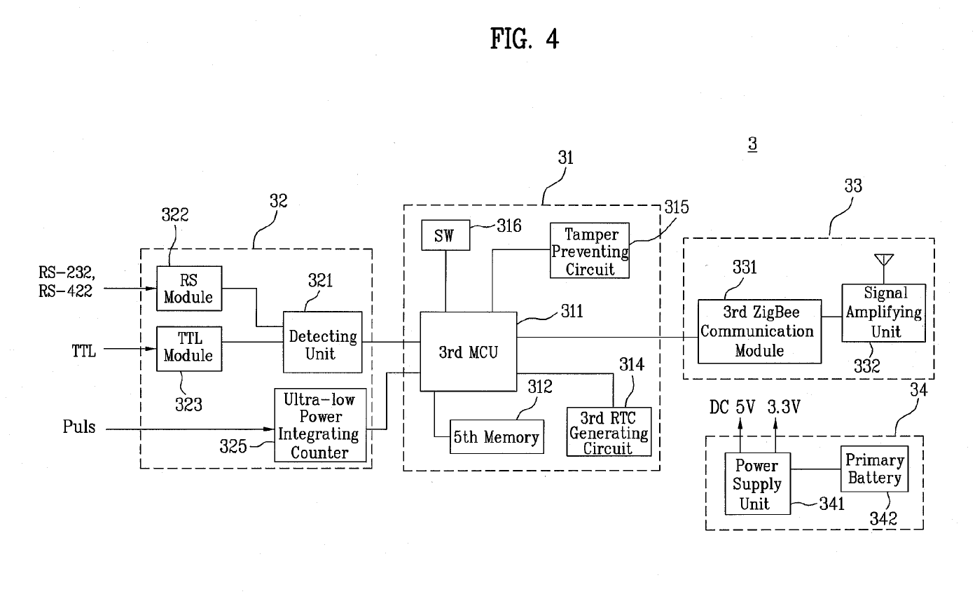

FIG. 4 is a schematic block diagram of a meter reading unit shown in FIG. 1.

Referring to FIG. 4, the meter reading unit 3 includes a detecting module 32 reading an integrated numerical value from a meter connected to itself and generating meter reading data corresponding to the integrated numerical value, a third ZigBee communication unit 33 supplying the meter reading data to the first ZigBee communication unit 13 or the second ZigBee communication unit 23 and supplied with the control signal and GPS time information from the first ZigBee communication unit 13 or the second ZigBee communication unit 23, a meter reading control unit 31 supplying the meter reading data from the detecting module 32 to the third ZigBee communication unit 33 and controlling the detecting module 32 and the third ZigBee communication unit 33 according to the control signal, and a third power unit 34 supplying power to the third ZigBee communication unit 33, the detecting module 32 and the meter reading control unit 31.

The above-configured meter reading unit 3 is electrically connected to at least one meter or may be built in one body of a meter. In particular, the meter reading unit 3 of the present invention reads an integrated numerical value from a meter according to the control signal. The meter reading unit 3 generates meter reading data by converting the read-in integrated numerical value to data and then enables the meter reading data to be transmitted to the meter reading server (MS) by supplying the meter reading data to the data centralizing unit 1 or the regenerative repeating unit 2.

The detecting module 32 includes an RS module 322 performing RS-232 or RS-422 communication to enable an interface with a meter located in a prescribed distance, a TTL module 323 enabling an interface with a meter located in a close distance, a detecting unit 321 generating meter reading data by reading an integrated numerical value of the meter transmitted from either the RS module 322 or the TTL module 323, and a ultra-low power integrating counter 325 generating meter reading data by receiving an integrated pulse from a pulse type meter located in a close distance or built in one body.

The above-configured detecting module 32 is provided to perform an interface (meter I/F) function with commercial meters of various manufacturers and is configured to enable an interface with various kinds of meters. In case of an industrial meter, since the meter reading unit 3 is installed in a prescribed distance from the corresponding meter, integrated numerical values are read in by applying RS-422 or RS-232 system. Meanwhile, in case of TTL type, a meter and the meter reading unit 3 like a home use are installed in a close distance in-between. In this case, since TTL level transmission enables errorless transmission, a TTL module transmittable at TTL level is used.

The detecting unit 321 reads the integrated numerical value on a meter transmitted from the RS module 322 or the TTL module 323 and then converts the read-in integrated numerical value to meter reading data transmittable to the meter reading server (MS) via a short-range wireless network (e.g., WPAN) or a long-distance network.

Pulses are inputted to the ultra-low power integrating counter 325 according to a use amount when the ultra-low power integrating counter 325 is connected to a pulse type meter. The ultra-low power integrating counter 325 performs calculation by counts the pulses inputted from the meter. In this case, since a timing point of generating a pulse from a meter is unknown, the ultra-low power integrating counter 325 is always maintained in an enabled mode. For this, the ultra-low power integrating counter 325 may need a ultra-low power below 0.5 μA to secure long-term durability by a primary battery or the like.

The third ZigBee communication unit 33 supplies meter reading data inputted via the meter reading control unit 31 to the first ZigBee communication unit 13 or the second ZigBee communication unit 23. The third ZigBee communication unit 33 transmits control signal and GPS time information inputted from the first ZigBee communication unit 13 or the second ZigBee communication unit 23 to the meter reading control unit 31.

The third ZigBee communication unit 33 includes a third ZigBee communication module 331 supplying the meter reading data to the first ZigBee communication unit 13 or the second ZigBee communication unit 23 and supplying control signal and GPS time information from the first ZigBee communication unit 13 or the second ZigBee communication unit 23 to the meter reading control unit 31, and a third signal amplifying unit 332 amplifying transmission and reception signals between the first ZigBee communication unit 13 or the second ZigBee communication unit 23 and the third ZigBee communication module 331.

The third ZigBee communication module 331 can include RFD (reduce function device) ZigBee module. Although RFD ZigBee module and FFD ZigBee module support communication protocols, respectively, they are discriminated from each other due to functional differences. In particular, the RFD (reduce function device) ZigBee module is provided with a basic function for ZigBee communication only. Hence, RFD ZigBee module is provided to each of the meter reading units 3, whereas FFD ZigBee module is provided to the data centralizing unit 1 and the regenerative repeating unit 2.

The third signal amplifying unit 332 has the same configuration of the first or second signal amplifying unit 132 or 232 and performs the same operation thereof.

The meter reading control unit 31 controls main elements of the meter reading unit 3 including the detecting module 32 and the third ZigBee communication unit 33 according to the control signal supplied via the data centralizing unit 1 or the regenerative repeating unit 2.

The meter reading control unit 31 includes a third tamper preventing circuit 315 generating a tamper signal by detecting switching and breakage of the meter reading unit 3, a third RTC generating circuit 314 periodically supplied with GPS time information, maintaining and correcting current time information according to the supplied GPS time information and outputting the maintained time information if the control signal is inputted, a third MCU 311 controlling operations of the main elements of the meter reading control unit 31 including the detecting module 31 and the third ZigBee communication unit 33 according to the control signal, receiving meter reading data via the detecting module 32 according to the control signal and supplying the received meter reading data to the first ZigBee communication unit 13 or the second ZigBee communication unit 23 via the third ZigBee communication unit 33, a fifth memory 312 storing basic operation program information of the third MCU 311, and a third switching unit 316 forcing the power of the meter reading unit 3 to be turned on/off and supplying information inputted from the user to the third MCU 311.

In this case, configurations and operations of the third tamper preventing circuit 315, the third RTC generating circuit 314 and the third switching unit 316 are identical to those of the first tamper preventing circuit 115, the first RTC generating circuit 114 and the first switching unit 116. So, details of the third tamper preventing circuit 315, the third RTC generating circuit 314 and the third switching unit 316 are quoted from those of the first tamper preventing circuit 115, the first RTC generating circuit 114 and the first switching unit 116.

The third MCU 311 controls an operation of each of the elements of the meter reading unit 3 according to the control signal supplied from the meter reading server (MS) via the third ZigBee communication unit 33.

In particular, if supplied with the control signal, the third MCU 311 generates state information according to the control signal and then supplies the generated state information to the third RTC generating circuit 314. And, the third MCU 311 controls the detecting unit 321 or the ultra-low power integrating counter 325 to have meter reading data inputted thereto. For instance, in case of attempting to generate meter reading data by controlling the ultra-low power integrating counter 325, the third MCU 311 converts integrated numerical values read in by the ultra-low power integrating counter 325, i.e., the counted integrated numerical value to the meter reading data. And, the third MCU 311 supplies the meter reading data to the third ZigBee communication unit 33 to enable the meter reading data to be transmitted to the data centralizing unit 1. Meanwhile, if a tamper signal is inputted from the third tamper preventing circuit 315, the third MCU 311 directly supplies state information according to the tamper signal to the third ZigBee communication unit 33 so that the state information can be supplied to the meter reading server (MS) via the data centralizing unit 1.

As mentioned in the foregoing description, the third MCU 311 can be supplied with the meter reading data by controlling the detecting unit 321 or the ultra-low power integrating counter 325 according to the control signal inputted from the data centralizing unit 1 via the second or third ZigBee communication unit 232 or 332. Meanwhile, the third MCU 311 uses the inputted control signal as the state information or converts the control signal to the state information, stores the corresponding state information in the third RTC generating circuit 314, and then enters a standby mode. If it is a meter reading time according to the GPS time information and the state information, the third RTC generating circuit 314 generates a meter reading signal and then supplies the generated meter reading signal to the third MCU 311. So, if the meter reading signal is supplied or if the control signal is inputted from the data centralizing unit 1, the third MCU 311 collects meter reading data by controlling the detecting unit 321 or the ultra-low power integrating counter 325 and then supplies the collected meter reading data to the data centralizing unit 1.

The fifth memory 312 has the same configuration of the first memory 112 and performs the same operation thereof. Hence, details of the fifth memory 312 are quoted from those of the first memory 112.

The third power unit 34 has the same configuration of the first power unit 14 and performs the same operation thereof. Hence, details of the third power unit 34 are quoted from those of the first power unit 14.

Finally, the meter reading server (MS) access the internet network 9 via the fixed IP and then collects the state information, the GPS time information and the meter reading data of each of the meter reading units 3 from the corresponding data centralizing unit 1 via the long-distance network using GSM and GPRS systems. In doing so, the meter reading server (MS) is able to carry out two kinds of methods to collect the meter reading data.

First of all, a first method is used to collect meter reading data immediately. In particular, the meter reading server (MS) generates a control signal containing a meter reading request command, supplies the generated control signal to each of the meter reading units 3 configuring the short-range wireless network (WPAN) via the long-range network, and is then supplied with the meter reading data detected by each of the meter reading units 3 using the short-range wireless network (WPAN), the long-range network and the internet network 9.

Secondly, a second method is used to collect meter reading data by presetting times for meter readings if it is the preset time. In particular, the meter reading server (MS) generates a control signal containing a meter reading request time and then supplies the generated control signal to each data centralizing unit 1 configuring the short-range wireless network (WPAN) via the internet network 9 and the long-range network. If it is the meter reading request time according to the GPS time information, the meter reading server (MS) is supplied with meter reading data collected from each of the meter reading units 3 by the corresponding data centralizing unit 1 via the long-range network and the internet network 9.

In this case, the meter reading server (MS) accesses the internet network 9 and the long-range network using the mobile communication GW 4 in generating and supplying the control signal to each of the data centralizing unit 1, the regenerative repeating unit 2 and the meter reading unit 3. In doing so, the mobile communication GW 4 plays a role as a gateway between the meter reading server (MS) and the long-range network.

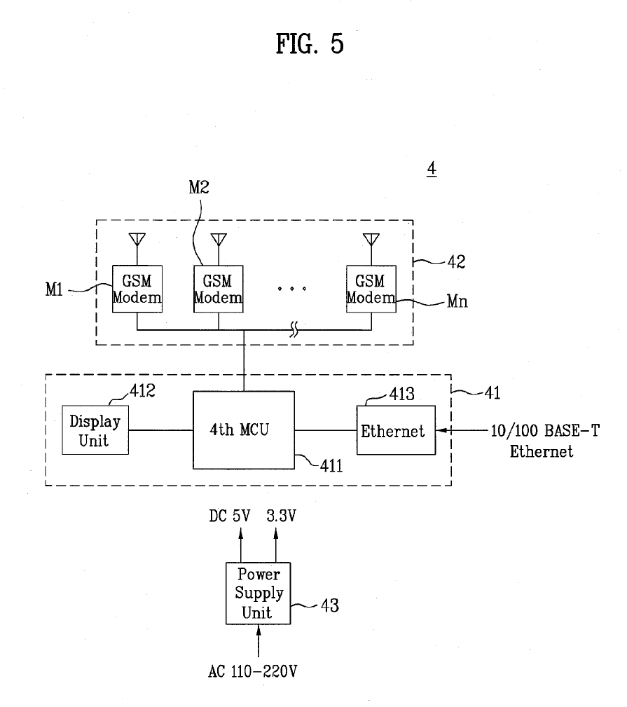

FIG. 5 is a schematic block diagram of a mobile communication GW shown in FIG. 1.

Referring to FIG. 5, the mobile communication GW 4 includes a third data communication unit 42 having a plurality of GSM modems M1 to Mn or CDMA modems (not shown in the drawing), a data control unit 41 enabling a long-range network and a network in a local area to interoperate with each other, and a fourth power unit 43 supplying powers to the third data communication unit 42 and the data control unit 41, respectively.

In case of configuring a long-range network by GSM, the third data communication unit 42 includes a plurality of GSM modems M1 to Mn. Alternatively, in case of configuring a long-range network by CDMA, the third data communication unit 42 includes a plurality of CDMA modems (not shown in the drawing). The above-configured third data communication unit 42 supplies meter reading data, state information, GPS time information and the like supplied via the long-range network to the data control unit 41. If a control signal is inputted from the data control unit 41, the third data communication unit 42 is able to forward the inputted control signal to the base station controller 6 or the base station 5. Thus, the third data communication unit 42 can include a plurality of the GSM modems M1 to Mn or a plurality of the CDMA modems according to the configuration for the long-range network in a meter reading area and is designed to extend to maximum 12 channels. In case of using a plurality of the GSM modems M1 to Mn, it is preferable that a front part is designed to facilitate SIM card to be loaded or unloaded.

The data control unit 41 includes an Ethernet control unit 413 performing network communication in a local area, a fourth MCU 411 controlling a plurality of the GSM modems M1 to Mn and the Ethernet control unit 413 and playing a role as a gateway with a long-range network by supplying a control signal inputted via the Ethernet control unit 413 to a plurality of the GSM modems M1 to Mn, and a display unit 412 displaying a power state of the mobile communication GW 4, an Ethernet connection state, a connection state of the third data communication unit 42 and the like.

In this case, the Ethernet control unit 413 performs MAC (media access controller) function by interfacing with the fourth MCU 411, supports 10/100Base-T Ethernet, plays a role as ZigBee-IP network gateway, and may support TCP/IP protocol.

The fourth power unit 43 has the same configuration of the first power unit 14. Preferably, the fourth power unit 43 is designed to meet total drive capability by considering the operational state in using 12-channel modem.

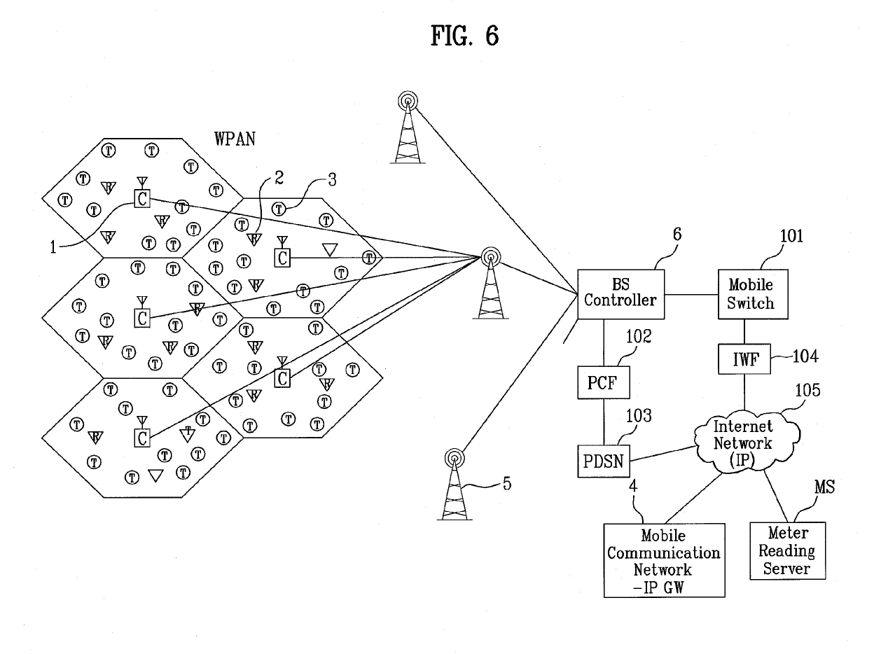

FIG. 6 is a schematic block diagram of a wireless remote meter reading apparatus using a long-range network by CDMA.

Referring to FIG. 6, a long-range network of the present invention interworks with such a wireless mobile communication network as CDMA communication network, whereby meter reading data collected from the a station 5 or a base station controller 6 to the meter reading server (MS) via an internet network 105.

In case of configuring a long-range network by CDMA, the same scheme for configuring a short-range wireless network (WPAN) and SMSC, as shown in FIGS. 1 to 4, is applicable. Yet, the interoperation between a mobile switch 101 and the internet network 105 is supported through IWF (interworking function) in case of the second generation mobile communication network. In case of the third generation mobile communication network, the base station controller 6 interworks with the internet network 105 directly via PCF (packet control function) and PDSN (packet data serving node) without using the mobile switch 101. In this manner, a meter reading server (MS) is supplied with meter reading data via the internet network 105 or a mobile communication gateway 4. The meter reading server (MS) is able to control a plurality of meter reading units 3, a plurality of regenerative repeating units 2 and each data centralizing unit 1 by supplying control signals to the meter reading unit 3, the regenerative repeating units 2 and the data centralizing unit 1 in a manner reverse to the former manner.

A method of driving a wireless remote meter reading apparatus according to an embodiment of the present invention is explained in detail as follows.

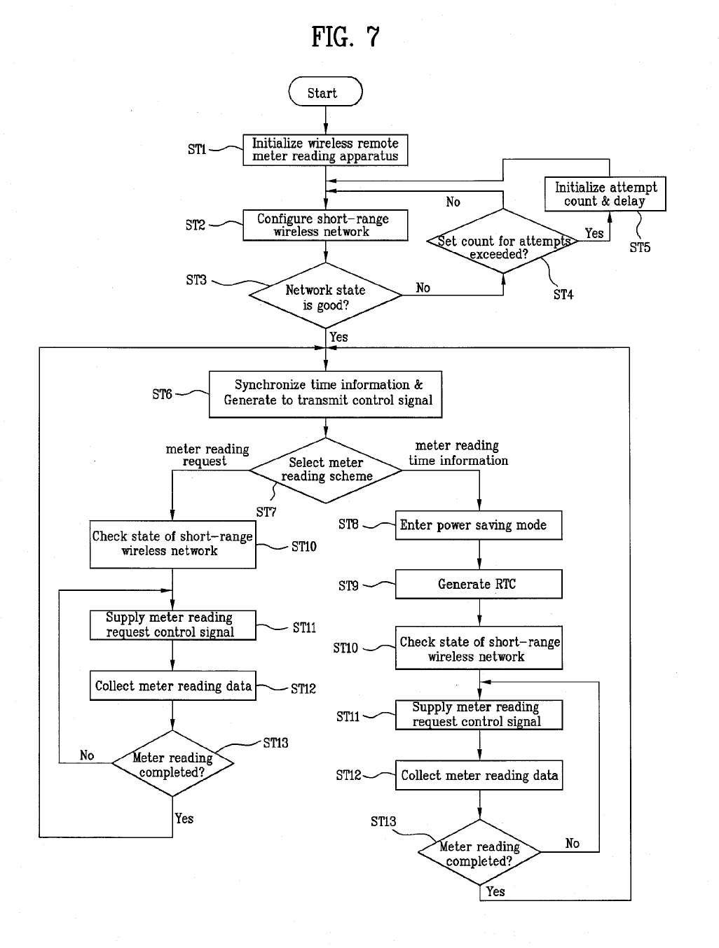

FIG. 7 is a flowchart for a method of driving a wireless remote meter reading apparatus according to an embodiment of the present invention.

Referring to FIG. 7, a method of driving a wireless remote meter reading apparatus according to an embodiment of the present invention includes the steps of initializing the wireless remote meter reading apparatus, generating and supplying a control signal to a data centralizing unit 1 via a long-range network, selecting a meter reading scheme by analyzing the control signal through the data centralizing unit 1, and collecting meter reading data according to the selected meter reading scheme by configuring a short-range network.

First of all, in the step of initializing the wireless remote meter reading apparatus, the data centralizing unit 1 receives GPS time information and location information using a first GPS module 1. The data centralizing unit then supplies state information containing the GPS time information and the location information to a meter reading server (MS) [ST1].

Subsequently, the data centralizing unit 1 configures a short-range wireless network (WPAN) centering on itself [ST2]. In this case, the data centralizing unit 1 synchronizes the GPS time information by transmitting/receiving the GPS time information to/from a regenerative repeating unit 2. The data centralizing unit 1 receives state informations from a plurality of regenerative repeating units 2 and a plurality of meter reading units 3, respectively and then transmits the state informations to the meter reading server (MS). The meter reading server (MS) receives the state informations from a plurality of the data centralizing units 1 and then decides a state of the short-range wireless network (WPAN) [ST3].

The meter reading server (MS) decides normality or abnormality of the location information, the GPS time information, tamper signal information and the like included in each of the state informations. If the state of the short-range wireless network (WPAN) is not good, a short-range wireless network (WPAN) is configured again centering on the data centralizing unit 1 [ST4].

Thus, if the state of the short-range wireless network (WPAN) is not good, the meter reading server (MS) repeats the step ST2 of configuring the short-range wireless network (WPAN) as many as a preset count. If the step ST2 of configuring the sort-range wireless network (WPAN) is repeatedly executed as many as the preset attempt count, a short-range wireless network (WPAN) is repeatedly configured again by initializing the attempt count with a random duration [ST5].

Thereafter, if the short-range wireless network (WPAN) is configured in a good state, the step of generating and supplying a control signal to a data centralizing unit 1 via a long-range network is executed.

In particular, the meter reading server (MS) synchronizes its time with times of each of the data centralizing units 1 and each of the regenerative repeating units 2. The meter reading server (MS) also generates the control signal and then supplies the generated control signal to each of the data centralizing units 1 via the long-range network [ST6]. In more particular, the meter reading server (MS) carries out synchronization between itself, each of the data centralizing units 1 and each of the regenerative repeating units 2. The meter reading server (MS) generates the control signal and then supplies the control signal to the data centralizing unit 1, on which the initializing step has been performed, via the long-range network.

In this case, the meter reading scheme for collecting the meter reading data is set via the control signal. Namely, the control signal is set different according to the meter reading scheme. In a first scheme, the meter reading data is immediately collected by requesting a meter reading when the control signal is supplied (scheme by a meter reading request). In a second scheme, time information for meter reading is set and the meter reading data are then collected according to the set time (scheme according to time information).

The data centralizing unit 1 analyzes the control signal inputted via the long-range network and then performs the scheme by the meter reading request or the scheme according to the meter reading time information [ST7].

The scheme by the meter reading request is explained as follows.

First of all, in case of performing the scheme by the meter reading request, the short-range wireless network should be maintained all the time. In this case, standby is maintained in a power saving mode until a control signal requesting a meter reading is inputted. If the control signal is inputted, a sate of the short-range wireless network (WPAN) is checked [ST10]. The step ST10 of checking the state of the short-range wireless network (WPAN) is identical to the operation of the short-range wireless network (WPAN) configuring step ST2 in part. In particular, it is able to check the state of the short-range wireless network (WPAN) by transmitting state information of the data centralizing unit 1, the regenerative repeating units 2 and the meter reading units 3, which configure the short-range wireless network (WPAN) to the meter reading server (MS).

Subsequently, the data centralizing unit 1 supplies the control signal from the meter reading server (MS) to each of the repeat control units 2 and each of the meter reading units 3 via a first ZigBee communication unit 13 [ST11].

If so, each of the meter reading units 3 having been supplied with the control signal via the data centralizing unit 1 or the corresponding repeat control unit 2 reads an integrated numerical value from a corresponding meter using a detecting module 32 provided to the corresponding meter reading unit 3. The meter reading unit 3 generates meter reading data by converting the read-in integrated numerical value to data and then transmits the generated meter reading data to the corresponding data centralizing unit 1 [ST2]. Thus, the data centralizing unit 1 provided to each cellularized meter reading unit collects a plurality of the meter reading data via the meter reading units 3 or the regenerative repeating units 2 and then supplies the collected meter reading data to the meter reading server (MS) using the long-range network.

Finally, the meter reading server (MS) fully collects the meter reading data from each of the data centralizing units 1 via the long-range network and then sets a presence or non-presence of meter reading completion [ST13]. In particular, if the meter reading data are not fully collected, the meter reading server (MS) supplies a control signal for requesting a meter reading to each of the data centralizing units 1 again to collect meter reading data. If the meter reading is completed, the meter reading server (MS) enables the short-range wireless network (WPAN) to enter a standby mode by supplying a meter reading completion signal to each of the data centralizing units 1.

The meter reading scheme according to the meter reading time information is explained as follows.

First of all, the meter reading scheme according to the meter reading time information is executed in case that time information for a meter reading is contained in a control signal inputted from the meter reading server (MS).

In particular, if the control signal containing the time information for the meter reading is inputted to each of the data centralizing units 1 in the control signal generating and transmitting step ST6, the corresponding data centralizing unit 1 makes the short-range wireless network (WPAN) enter a power saving mode and then stands by [ST8].

Namely, the data centralizing unit 1 supplies the meter reading time information contained in the control signal to the corresponding RTC generating circuit 114 and stores it therein. And, the data centralizing unit 1 supplies the meter reading time information to the corresponding regenerative repeating unit 2 and the corresponding meter reading unit 3 via the first ZigBee communication unit 13. The data centralizing unit 1 maintains the standby state in the power saving mode. Moreover, the regenerative repeating unit 2 and the meter reading unit 3 supply the inputted meter reading time information to the second RTC generating circuit 214 and the third RTC generating circuit 314, respectively and then maintains the standby state in the power saving mode.

Subsequently, each of the first to third RTC generating circuits 114, 214 and 314 keeps maintaining the GPS time information. If it is the meter reading time, each of the first to third RTC generating circuits 114, 214 and 314 generates an RTC and then makes the short-range wireless network (WPAN) enter an enabled state [ST9]. In particular, if it is the meter reading time, the first to third RTC generating circuits 114, 214 and 314 generate RTCs and then make the first to third MCUs 111, 211 and 311 enter the enabled states, respectively.

If the RTCs are generated from the first to third RTC generating circuits 114, 214 and 314, respectively, the data centralizing unit 1, as mentioned in the foregoing description, the regenerative repeating unit 2 and the meter reading unit 3 sequentially execute 10^{th} to 13^{th} steps ST10 to ST13. In particular, after the state of the short-range wireless network (WPAN) has been confirmed [ST10], the data centralizing unit 1 supplies a meter reading request signal to each of the repeat control units 2 and each of the meter reading units 3 via the first ZigBee communication unit 13

If so, all the meter reading units 3 supplied with the control signal via the corresponding repeat control units 2 read integrated numerical values from meters using the corresponding detecting modules 32, respectively. Meter reading data are generated by converting the read-in integrated numerical values to data and are then transmitted back to the data centralizing unit 1 [ST12]. Thus, the data centralizing unit 1 provided to each of the cellularized meter reading units collects a plurality of the meter reading data from the corresponding meter reading units 3 or the corresponding regenerative repeating units 2 and then supplies the collected meter reading data to the meter reading server (MS) using the long-range network.

Finally, the meter reading server (MS) fully collects a plurality of the meter reading data from the data centralizing units 1 and then sets whether the meter reading is completed or not [ST13]. In particular, if the meter reading data are not fully collected, the meter reading server (MS) supplies a control signal for requesting a meter reading to each of the data centralizing units 1 again to collect the meter reading data. If the meter reading is completed, the meter reading server (MS) makes the short-range wireless network (WPAN) enter a standby mode by supplying a meter reading completion signal and a control signal containing next meter reading time information to each of the data centralizing units 1.

Accordingly, the present invention provides the following effects and/or advantages.

First of all, the present invention facilitates an energy consumption amount of tap water, gas, electricity, calorie or the like to be detected, thereby reducing a meter reading cost for detecting the energy consumption amount. Secondly, the present invention raises detection efficiency of an energy consumption amount and enables data collection for energy management and supply planning and accurate pattern analysis. Thirdly, the present invention establishes a short-range wireless communication network and a long-range backbone network to transmit meter reading data, thereby enabling an inexpensive cost for establishing a wireless remote meter reading apparatus.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A wireless remote meter reading apparatus comprising:
a plurality of short-range wireless networks, each comprising a plurality of meter reading units respectively having ZigBee communication modules, a plurality of regenerative repeating units and a data centralizing unit, to configure a cell unit;
a base station controller collecting a plurality of meter-reading data from a plurality of the short-range wireless networks configured by the cell unit via at least one base station; and
a meter reading server supplying a control signal to a plurality of the meter reading units, a plurality of the regenerative repeating units and the data centralizing unit using at least one long-range network selected from the group consisting of GSM, GPRS, CDMA, SMSC via a mobile switch and an internet network, the meter reading server supplied with a plurality of the meter reading data via the long-range network.

2. The wireless remote meter reading apparatus of claim 1, the data centralizing unit comprising:
a first data communication unit generating GPS time, the first data communication unit transmitting/receiving the control signal from the meter reading server and the meter reading data by communication with the base station;
a first ZigBee communication unit receiving the meter reading data from each of the meter reading units and each of the regenerative repeating units, the first ZigBee communication unit transmitting the control signal to each of the meter reading units and each of the regenerative repeating units;
a centralized control unit controlling the first ZigBee communication unit and the first data communication unit according to the GPS time information and the control signal; and
a first power unit supplying powers to the first ZigBee communication unit, the first data communication unit and the centralized control unit, respectively.

3. The wireless remote meter reading apparatus of claim 1, the first data communication unit comprising:
a GSM modem having an SIM card to perform GSM communication;
a CDMA modem performing CDMA communication;
a first LAN interface unit performing network communication in a local area;
a first GPS module generating the GPS time information and location information; and
a first selecting unit transmitting the GPS time information and the location information to the centralizing control unit according to a selection signal from the centralizing control unit, the first selecting unit receiving the control signal from one selected from the group consisting of the GSM modem, the CDMA modem and the first LAN interface unit and then transmitting the received control signal to the centralized control unit according to the selection signal.

4. The wireless remote meter reading apparatus of claim 3, the first ZigBee communication unit comprising:
a first ZigBee communication module transmitting a plurality of the meter reading data from a plurality of the meter reading units and a plurality of the regenerative repeating units to the centralized control unit, the first ZigBee communication unit transmitting the control signal from the centralized control unit and the GPS time information to each of a plurality of the meter reading units and each of a plurality of the regenerative repeating units; and
a first signal amplifying unit amplifying transmission and reception signals between the first ZigBee communication module and each of a plurality of the meter reading units or each of a plurality of the regenerative repeating units.

5. The wireless remote meter reading apparatus of claim 4, the centralized control unit comprising:
a tamper preventing circuit generating a tamper signal by detecting switching and breakage of the data centralizing unit;
a first RTC generating unit supplied with the GPS time information, the first RTC generating unit maintaining and correcting current time information according to the supplied GPS time information, the first RTC generating unit setting a meter reading time according to the maintained time information and the control signal and the first RTC generating unit generating a meter reading signal every the set meter reading time;
a first MCU (microcontroller circuit unit) controlling operation of the data centralizing unit including the first data communication unit and the first ZigBee communication unit according to the control signal, the first MCU receiving a plurality of the meter reading data via the first ZigBee communication unit according to the control signal and the meter reading signal, the first MCU supplying a plurality of the received meter reading data to the first data communication unit;
a first memory storing basic operation program information of the first MCU;
a second memory storing state information inputted from the first MCU and informations inputted from a user, the second memory storing configuration information of the short-range wireless network; and
a first switching unit turning on/off a power of the first data centralizing unit, the first switching unit supplying the information inputted from the user to the first MCU.

6. The wireless remote meter reading apparatus of claim 5, the regenerative repeating unit comprising:
a second data communication unit generating the GPS time information, the second data communication unit performing communication with the base station or the data centralizing unit according to the selection signal;
a second ZigBee communication unit receiving meter reading data from the corresponding meter reading unit set correspondent to the second ZigBee communication unit, the second ZigBee communication unit supplying the received meter reading data to the data centralizing unit, the second ZigBee communication unit transmitting the control signal from the data centralizing unit to the corresponding meter reading unit;
a repeat control unit controlling the second ZigBee communication unit and the second data communication unit according to the GPS time information and the control signal; and
a second power unit supplying powers to the second ZigBee communication unit, the second data communication unit and the repeat control unit.

7. The wireless remote meter reading apparatus of claim 6, the second data communication unit comprising:
a second LAN interface unit performing network communication in a local area;
a second GPS module generating the GPS time information and the location information; and
a second selecting unit transmitting the GPS time information and the location information to the repeat control unit, the second selecting unit performing communication with the base station via the second LAN interface unit according to the selection signal.

8. The wireless remote meter reading apparatus of claim 7, the second ZigBee communication unit comprising:
a second ZigBee communication module supplying the meter reading data from the meter reading unit to the repeat control unit, the second ZigBee communication module transmitting the control signal and the GPS time information from the repeat control unit to the meter reading unit; and
a second signal amplifying unit amplifying transmission and reception signals between the corresponding meter reading unit and the second ZigBee communication module.

9. The wireless remote meter reading apparatus of claim 8, the repeat control unit comprising:
a second tamper preventing circuit generating a tamper signal by detecting switching and breakage of the repeat control unit;, a second RTC generating circuit periodically supplied with the GPS time information, the second RTC generating circuit maintaining and correcting current time information according to the supplied GPS time information, the second RTC generating circuit outputting the maintained time information if the control signal is inputted;
a second MCU controlling operations of elements of the repeat control unit including the second data communication unit and the second ZigBee communication unit according to the control signal, the second MCU receiving a plurality of meter reading data via the second ZigBee communication unit according to the control signal, the second MCU supplying the received meter reading data back to the first ZigBee communication unit via the second ZigBee communication unit;
a third memory storing basic operation program information of the second MCU;
a fourth memory storing state information inputted from the second MCU and informations inputted from a user, the fourth memory storing configuration information of the short-range wireless network; and
a second switching unit forcibly turning on/off the power of the regenerative repeating unit, the second switching unit supplying information inputted from the user to the second MCU.

10. The wireless remote meter reading apparatus of claim 9, the meter reading unit comprising:
a detecting module reading an integrated numerical value from a meter electrically connected to the detecting module, the detecting module generating meter reading data corresponding to the integrated numerical value;
a third ZigBee communication unit supplying the meter reading data to the first ZigBee communication unit or the second ZigBee communication unit, the third ZigBee communication unit supplied with the control signal and the GPS time information from the first ZigBee communication unit or the second ZigBee communication unit;
a meter reading control unit supplying the meter reading data from the detecting module to the third ZigBee communication unit, the meter reading control unit controlling the detecting module and the third ZigBee communication unit according to the control signal; and
a third power unit supplying powers to the third ZigBee communication unit, the detecting module and the meter reading control unit.

11. The wireless remote meter reading apparatus of claim 10, the detecting module comprising:
an RS module performing RS-232 or RS-422 communication to enable an interface with the meter;
a TTL module enabling an interface with the meter;
a detecting unit generating the meter reading data by reading an integrated numerical value of the meter transmitted from the RS module or the TTL module; and
a ultra-low power integrating counter generating the meter reading data by receiving an integrated pulse from a pulse type meter.

12. The wireless remote meter reading apparatus of claim 11, the third ZigBee communication unit comprising:
a third ZigBee communication module supplying the meter reading data to the first ZigBee communication unit or the second ZigBee communication unit, the third ZigBee communication module supplying the control signal and the GPS time information from the first ZigBee communication unit or the second ZigBee communication unit to the meter reading control unit; and
a third signal amplifying unit amplifying transmission and reception signals between the first ZigBee communication unit or the second ZigBee communication unit and the third ZigBee communication module.

13. The wireless remote meter reading apparatus of claim 12, the meter reading control unit comprising:
a third tamper preventing circuit generating a tamper signal by detecting switching and breakage of the meter reading unit;
a third RTC generating circuit periodically supplied with the GPS time information, the third RTC generating circuit maintaining and correcting current time information according to the supplied GPS time information, the third RTC generating circuit outputting the maintained time information if the control signal is inputted;
a third MCU controlling operations of main elements of the meter reading control unit including the detecting module and the third ZigBee communication unit according to the control signal, the third MCU receiving a plurality of the meter reading data via the detecting module according to the control signal, the third MCU supplying the received meter reading data to the first ZigBee communication unit or the second ZigBee communication unit via the third ZigBee communication unit;
a fifth memory storing basic operation program information of the third MCU; and
a third switching unit forcing the power of the meter reading unit to be turned on/off, the third switching unit supplying information inputted from the user to the third MCU.

14. The wireless remote meter reading apparatus of claim 1, further comprising a mobile communication GW controlling each of the meter reading units, each of the regenerative repeating units and the data centralizing unit via the meter reading server by playing a role as a gateway between the meter reading server and the long-range network.

15. The wireless remote meter reading apparatus of claim 14, the mobile communication GW comprising:
a third data communication unit having a plurality of GSM modems or a plurality of CDMA modems;
a data control unit enabling the long-range network and a network in a local area to interwork with each other; and
a fourth power unit supplying powers to the third data communication unit and the data control unit, respectively.

16. The wireless remote meter reading apparatus of claim 15, the data control unit comprising:
an Ethernet control unit performing network communication in the local area;
a fourth MCU controlling a plurality of the GSM modems or a plurality of the CDMA modems and the Ethernet control unit, the fourth MCU playing a role as a gateway with the long-range network by supplying the control signal inputted via the Ethernet control unit to a plurality of the GSM modems or a plurality of the CDMA modems; and
a display unit displaying a power state of the mobile communication GW, an Ethernet connection state and a connection state of the third data communication unit.

17. A method of driving a wireless remote meter reading apparatus, the wireless remote meter reading apparatus comprising a plurality of short-range wireless networks, each comprising a plurality of meter reading units respectively having ZigBee communication modules, a plurality of regenerative repeating units and a data centralizing unit, to configure a cell unit and a meter reading server supplied with a plurality of the meter reading data using at least one long-range network selected from the group consisting of GSM, GPRS, CDMA, SMSC via a mobile switch and an internet network, the method comprising the steps of:
initializing the wireless remote meter reading apparatus;
generating and supplying a control signal to the data centralizing unit via the long-range network;
selecting a meter reading scheme by analyzing the control signal through the data centralizing unit; and
collecting the meter reading data according to the selected meter reading scheme by configuring a short-range network.

18. The method of claim 17, the wireless remote meter reading apparatus initializing step comprising the steps of:
receiving GPS time information and location information by the data centralizing unit using a first GPS module;
supplying state information including the received GPS time information and the location information to the meter reading server;
configuring the short-range wireless network by the data centralizing unit;
synchronizing the GPS time information in a manner that the data centralizing unit transmits and receives the GPS type information with the regenerative repeating unit;
receiving the state information from each of the regenerative repeating unit and the meter reading unit by the data centralizing unit;
transmitting the received state information to the meter reading server from the data centralizing unit; and
deciding a state of the short-range wireless network in a manner that the meter reading server receives the state information.

19. The method of claim 18, the control signal generating and supplying step comprising the steps of:
synchronizing times of the meter reading server, the data centralizing unit and the regenerative repeating units with each other; and
generating the control signal to execute either a scheme by a meter reading request or a scheme according to meter reading time information to collect the meter reading data.

20. The method of claim 19, the meter reading data collecting step comprising the steps of:
analyzing the control signal;
checking the state of the short-range wireless network according to the analyzed control signal;
supplying the control signal to the repeat control unit and the meter reading unit;
reading an integrated numerical value from each meter by the meter reading unit using a detecting module;
generating meter reading data by converting the read integrated numerical value to data;
transmitting the meter reading data to the data centralizing unit;
collecting the meter reading data by the data centralizing unit; and
supplying the collected meter reading data to the meter reading server by the data centralizing unit using the long-range network.

21. The method of claim 20, the meter reading data collecting step comprising the steps of:
analyzing the control signal;
enabling the short-range wireless network to enter a power saving mode and stand by according to the analyzed control signal;
generating a meter reading signal according to the GPS time information and the control signal;
switching the short-range network into an enabled state according to the meter reading signal;
checking a connection state of the short-range wireless network;
supplying the control signal to the repeat control unit and the meter reading unit;
reading the integrated numerical value from the each meter by the meter reading unit using the detecting module;
generating the meter reading data by converting the read integrated numerical value to data;
transmitting the meter reading data to the data centralizing unit;
collecting the meter reading data by the data centralizing unit; and
supplying the collected meter reading data to the meter reading server by the data centralizing unit using the long-range network.
